(19) United States
(12) Patent Application Publication
(10) Pub. No.: US 2016/0219859 A1
(43) Pub. Date: Aug. 4, 2016

(54) ORGANISM CONTROL DEVICE AND METHOD

(71) Applicant: UVAS, LLC, Charleston, SC (US)

(72) Inventor: Jeffery L. Deal, Charleston, SC (US)

(73) Assignee: UVAS, LLC, Charleston, SC (US)

(21) Appl. No.: 14/988,587

(22) Filed: Jan. 5, 2016

Related U.S. Application Data
(60) Provisional application No. 62/099,624, filed on Jan. 5, 2015.

(51) Int. Cl. A01M 1/20; C01B 13/10

(52) U.S. Cl. CPC A01M 1/20; C01B 13/10

(57) ABSTRACT

Pest control in an enclosed area, such as a room of a building, by positioning an ozone producing device in an area to be treated. Ozone generating ultraviolet lamps emit ozone around the entire perimeter of the device, generating ozone from the atmosphere within the enclosed area. A concentration of ozone in the area is measured by a sensor. Production of ozone by the ozone generating ultraviolet lamps is terminated upon the ozone concentration reaching a predetermined concentration of ozone or by time of exposure. Pests that are subject to treatment include invertebrates, such as insects and arachnids, or small mammals, such as mice and rats.

Applicant claims the benefit of U.S. Provisional Application Ser. No. 62/099,624 filed Jan. 5, 2015.

### FIELD OF THE INVENTION

This invention is directed to a method and device for controlling microorganisms and macroorganisms.

### BACKGROUND OF THE INVENTION

Nosocomial, or hospital acquired, infections are common, costly and sometimes lethal. A recent review of such infections in the cardiac surgery unit of a major hospital revealed a nosocomial infection rate of 27.3% that more than doubled the mortality rate for afflicted patients. The nature of bacteria acquired in the hospital setting differs significantly from bacteria found in other settings, such as increased resistance to antibiotic therapy.

Significant morbidity, mortality and costs are associated with these infections. Many factors contribute to these dangerous infections. Most notably is the overuse of antibiotics and poor personal hygiene such as inadequate handwashing. Abundant evidence exists, however, that the hospital environment itself contributes to the problem by harboring virulent strains of bacteria, fungi and viruses, and that many methods commonly used are ineffective and may actually spread contaminants.

Attempts to eradicate surface contaminates from the hospital setting have varied greatly in strategy and success. These have ranged from antiseptic soaps to fumigation with formaldehyde gas. Topical antiseptics are problematic. They have been shown to induce antibiotic resistances and may contribute to disinfection problems. Secondly, many surfaces such as keyboards, television sets and monitoring controls are difficult if not impossible to decontaminate with liquid disinfectants without harming the electronics.

Pesticides are an environmental and safety hazard. Residual pesticides present a hazard to humans and pets. Pest infestations are increasingly difficult to manage without the use of chemical agents with their subsequent residual contamination. Residual pesticides may remain on surfaces in buildings for extended periods.

A need exists for disinfection of organisms that is achieved by methods other than those relying on chemical compounds, and will likely continue to exist. Non-chemical disinfection methods hold the most promise in eliminating infectious surface contaminates without creating resistance of pathogens to the disinfecting agent.

### SUMMARY OF THE INVENTION

The present invention is a disinfecting device that is particularly useful in enclosed areas. The device is a broadband ultraviolet (UV) generator that may comprise ultraviolet generating lamps, which in turn ionize ambient oxygen into ozone. The ozone disinfects the area in which the device is employed.

Ozone in sufficient concentrations is lethal to all micro-organisms. Ozone in sufficient concentrations is also lethal to macroorganisms, including such pests as bedbugs, lice, rodents, and other arthropods. Ozone, while lethal to microorganisms and macroorganisms, rapidly degenerates into oxygen with no residual chemicals.

Broadband ultraviolet (UV) generators generate ozone within an area. One or more sensors measure broadband UV generation and/or levels of ozone generated in the area, and terminate operation of the broadband UV generators after required levels of broadband UV are emitted and/or required levels of ozone are present. The device and method of the invention disinfects surfaces in the enclosed area and controls pests that are present within the area, including pests that are present in cracks and crevices treatment where pest infestation occurs and recurs.

### BRIEF DRAWING DESCRIPTION

FIG. 1 is a perspective view of an embodiment of the device.

FIG. 2 is a partial view of the device of FIG. 1 taken essentially along line 2-2.

FIG. 3 is a partial view of the device of FIG. 1 taken essentially along line 3-3.

FIG. 4 is a sectioned elevation of an embodiment of the device.

FIG. 5 is a partial view of the device of FIG. 4 taken essentially along line 5-5.

FIG. 6 is an elevation of an embodiment of the device.

FIG. 7 demonstrates use of an embodiment in an enclosed area such as a room.

### DESCRIPTION OF PREFERRED EMBODIMENTS

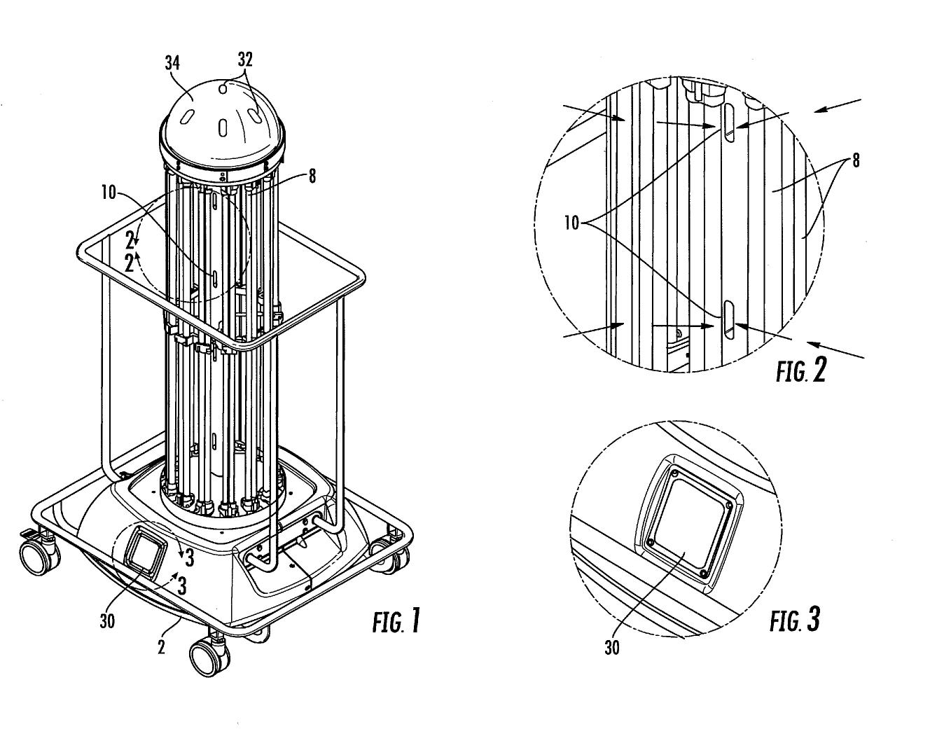

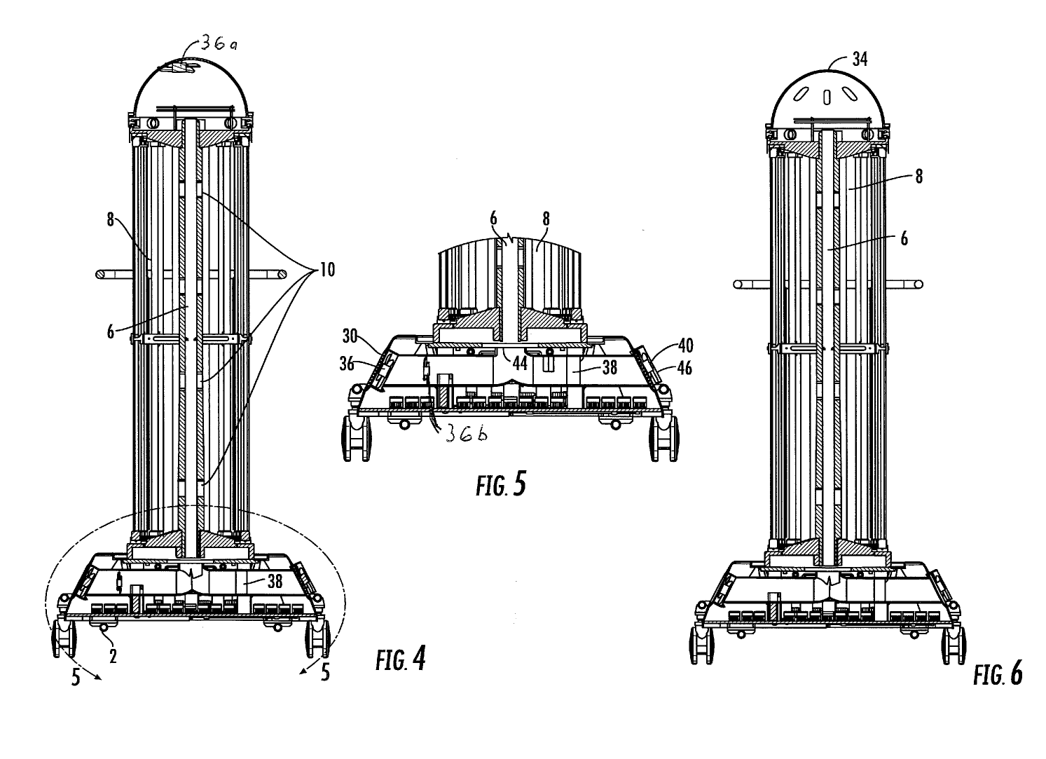

Referring now to the drawing figures, a device according to the invention may be mounted on a rolling base 2 to provide portability. FIG. 1. A column 6 may extend upwardly from the base.

A plurality of broadband UV emitters may be positioned around the column in a generally vertical orientation. In the embodiment as shown in the drawings, ozone producing ultraviolet lamps 8 are present. Each lamp, or pairs of lamps 8, may be positioned in an equidistant manner from the adjoining lamps on each side, so that lamps are positioned around the circumference of the device to provide UV and ozone production 360° around the device.

In one embodiment, the ozone producing ultraviolet lamps are 48 inches long, 115-watt germicidal lamps that produce 300 microwatts of ultraviolet radiation at 1 meter. Other lengths of lamps and/or wattages of lamps may be used according to the application. The lamps are preferred to be positioned relative to each other so that 360° coverage is assured. Other configurations of ozone producing ultraviolet lamps or broadband UV emitters may be used that provide ozone coverage in an area for 360° around the device. The lamps may be medium pressure ozone producing ultraviolet lamps. Emitters may be provided that emit broadband UV and/or ozone above and below the device.

The number and type of ozone producing ultraviolet lamps may be chosen according to the requirements of the pest control application. The output of the ozone producing ultraviolet lamps may be varied according to the requirements of the pest control application, up to the maximum output of the lamps chosen. The time of operation of the ozone producing ultraviolet lamps may be varied according to the requirements of the pest control application.

Broadband UV is a high frequency wavelength of light within the ultraviolet band, having wavelengths of about 100 nm to 300 nm. Other forms of broadband UV emitters may be used, such as a plurality of broadband UV emitting light emitting diodes (LEDs), preferably positioned and used in sufficient quantity to emit broadband UV radiation 360° around the device and, in some applications, above the device.

The device may comprise additional ozone generators that are positioned to discharge ozone around and/or above the device. Ozone is preferably emitted concurrently with broadband UV emission by the device.

One or more fans 36a, 36b may be present as part of the device to distribute the ozone, so that distribution of ozone around the device and throughout the room or other enclosed area is enhanced. In one embodiment, an inlet 30 is provided on a lower portion of the device. Fan 36b in the base creates negative pressure to pull ambient air into the base 2. The ambient air is pushed by the fan out of the base and into an interior of the lamp array, which is the area between the lamps and above the base. The inlet may be positioned under the device, such as underneath base 2 on a bottom surface thereof. Ozone is produced by the ozone producing ultraviolet lamps from the ambient air received from the room or other enclosed area.

The lamps produce ozone by ionizing the ambient air from the room atmosphere. To further distribute ozone, fans may be used. In one embodiment, outlets 32 are provided that communicate with the interior of the bulb array. The outlets may be positioned on the top 34 of the device. Ozone infused air is pulled into the top of the device from the lamp array by a fan or fans, such as fan 36a, and the ozone infused air is forced out of the device by a fan or fans in the top 34, with the outlets 32 preferably constructed and arranged to distribute the ozone 360° around the device, and throughout the room or other enclosed area. The top may be supported by column 6, which may provide a conduit for air or ozone, and may provide communication between the base 2 and the top 34. The top also provides support for the lamps in this embodiment.

In an embodiment, a fan or fans pull air into the interior of the lamp array and force ozone infused air out of the outlets 32 of the device. Optionally, intakes 10 may communicate with the column 6, which acts as a conduit to deliver ozone to outlets 32. The intakes, with a fan or fans, such as fan 36a, creating negative pressure, harvest ozone from the interior of the lamp array, particularly near the bottom of the array, where the heavier than air ozone will tend to settle.

Inlet 30 may be part of a forced air return in an embodiment. Negative pressure provided through the air return inlet pulls air into the device for exposure to the ozone producing lamps. Over a period of time after actuation and operation of the device, air in the room comprises increasing levels of ozone. The ozone infused air is continuously pulled back to the device and through the inlet for exposure to the sensor. The ozone infused air within the room is measured by the sensor, and preferably measured on a continuous basis while the device is producing ozone. After the enclosed area has achieved a desired ozone concentration, as measured by the sensor 36 or sensors, ozone production is terminated.

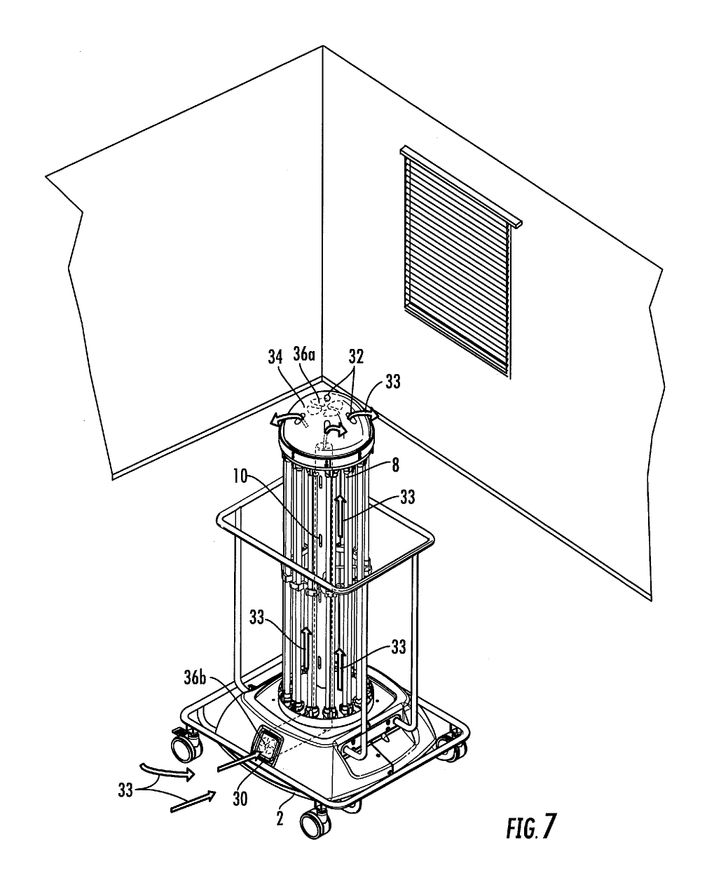

An exemplary use of the device is described. Pest control in an enclosed area, such as a room of a building, may be accomplished by positioning the ozone producing device in an area, such as in an approximate center of the area to be treated. FIG. 7. The ozone generating ultraviolet lamps of the device should offer emission of ozone around the entire perimeter of the device, which may be 360° around the device. The device is actuated to cause the ozone generating ultraviolet lamps to generate ozone from the atmosphere within the enclosed area of the building, which will typically be the ambient air in the enclosed area.

The ozone concentration in the atmosphere of the treatment area will rise as the device operates. The concentration of ozone is measured by the sensor. Production of ozone by the ozone generating ultraviolet lamps is terminated upon the ozone concentration of the atmosphere of the enclosed area of the building reaching a predetermined concentration of ozone as measured by the sensor. The predetermined concentration is a function of factors including: the organism to be killed; the degree of infestation; and the size of the area to be treated. Pests that are subject to treatment include invertebrates, such as insects and arachnids, or small mammals, such as mice and rats.

In another embodiment, the device is employed as described immediately above for multiple continuous cycles. The device continues to monitor the ozone concentration of the ozone in the atmosphere of the enclosed area of the building after terminating generation of ozone. Upon the sensor determining that ozone concentration has fallen below a predetermined concentration, the ozone generating ultraviolet lamps actuate to again generate ozone within the enclosed area to the desired level.

The operational cycles as described above may be repeated for a predetermined number of cycles, or for a predetermined aggregate period of time, or the cyclical process may be terminated by a human operator. Since very few areas of buildings are air tight, ozone levels will drop appreciably over time in most applications. At the same time, very high concentrations of ozone may cause unacceptable depreciation of objects in the area that is treated. Cyclical operation over time with relatively lower maximum concentrations may be preferred over a high ozone concentration for a single cycle in some applications.

The predetermined period of time of operation, or the number of cycles of operation, is a function of factors including: the organism to be killed; the degree of infestation; the ozone concentration level; and the size of the area to be treated. The predetermined concentration may be varied for each cycle in one embodiment. For example, the concentration may be reduced with progressive cycles to bring the concentration ozone down, and closer to the makeup of normal atmosphere, as the process progresses.

In a preferred embodiment, the predetermined concentration of ozone in the room atmosphere is not less than 1600 parts per million. A theoretical maximum concentration of ozone to be achieved is 140,000 parts per million which, in essence, ionizes all or substantially all of the ambient oxygen in the room.

In an example of use, the ozone generating ultraviolet lamps generate ozone by ionizing atmosphere within the enclosed area of the building and, concurrently with generating ozone, produce the ozone directly into the atmosphere of the enclosed area. The ozone is not generated in a chamber or similar container for subsequently release of the ozone from the container.

Where expedited reoccupation of a space is required, an ozone removal system may be used. When the ozone emission cycle is complete, due to, for example, the desired ozone levels as measured by the sensor have been reached, or a preset time is elapsed, the ozone removal device may be actuated. The device creates negative air pressure by the fan to pull ozone infused room air into an ozone removal device. The ozone removal device may be a filter 38, such as a charcoal filter, that removes residual ozone to achieve environmentally safe levels. The sensor 36 may then indicate to the operator, such as by a controller, that ozone levels have reached acceptable levels for human exposure.

In one embodiment, a valve or baffle 44 closes the opening to the interior of the bulb array, and directs the ozone infused air through the filter 38. Air exits an outlet 40 after passing through the filter, which reduces the ozone concentration.

An optional additional sensor 46 on the outlet side of the filter 38 is preferred. The additional sensor verifies the efficacy of ozone removal by the removal device, such as the charcoal filter, by comparing the ozone levels before and after treatment by the charcoal filter. If the ozone levels at sensor 36 are not materially less than the ozone levels at sensor 46, the filter may be due for servicing or replacement.

An example of a protocol for using the device is described.

1. An operator positions the device in a room to be disinfected. After checking the room for occupants, the operator leaves and secures doors to the room.
2. After securing the room, the operator enters a security code into an actuator, which may be a wireless remote control, and actuates the device.
3. Optional audible voice alarms and motion detectors activate, and may stay activated until the entire cycle is completed.
4. Motion detectors may stay on for a preset time, such as one minute, prior to powering the broadband UV and ozone emitters, and stay active until the cycle is complete and the emitters are powered down. Should the device detect motion in the enclosed area, the unit automatically deactivates.
5. The UV emitters/ozone generators are powered, and when sufficient time has elapsed to allow the emitters to reach a steady state output (typically one minute or less), the controller reads data from individual sensors, primarily of the ozone levels.
6 a. Sensor data regarding ozone and reflected broadband ultraviolet radiation received by the unit is recorded. When a predetermined level of ozone is reached, and/or a predetermined level of ozone is reached and maintained for a predetermined time, and/or a predetermined cumulative amount of broadband ultraviolet radiation is received, the ozone generating ultraviolet lamps and/or broadband ultraviolet emitters shut down. The level of ozone may be reduced to safe levels, such as by use of the filter. The unit may power down, except for the sensor, which indicates that the ozone level of the enclosed area is safe for human occupancy.
6 b. In another embodiment, only ozone levels are measured, since ozone processing time will generally exceed UVC radiation processing time. When ozone levels received through the inlet, and measured by the sensor, reach the desired level, ozone generation is terminated. The valve or baffle may be closed in this embodiment, and air received through the inlet is routed through the filter to remove ozone. When the sensor, or if used, when the sensor on the inlet side and the sensor on the outlet side, have reached “safe” ozone levels, the unit terminates operations.

Upon completion of the cycle, the unit has disinfected pathogens and/or arthropod infestations within the area of application, such as the enclosed area, such as a room.

In many rooms, radiation opaque objects that tend to block broadband UV radiation are positioned in a lower part of the room. While the device is effective at using reflected radiation to expose room surfaces to pathogenic killing radiation, ozone further improves efficacy of the device without the use of chemical compounds. Ozone is heavier than air, and tends to migrate to lower parts of the room where objects that block radiation are more likely to be located. Objects that do not receive direct or reflected radiation are exposed to ozone at levels that kill undesired pathogens.

The device is able to sanitize or sterilize all exposed surfaces in a room. It is able to do so safely, leave no residual toxin or radiation, and generates no adverse environmental side products. In addition, the device may be constructed to notify the operator of the time required to perform this task and automatically shut down upon completion of disinfection.

Paints and coatings that reflect rather than absorb broadband UV radiation may be used to improve efficiency and efficacy of the device to kill microorganisms by UV exposure. Specialty reflective paints may be used with the method of area sterilization according to the invention.

The combination of UVC and ozone provides coverage for disinfection in a room that exceeds the use of UVC or ozone alone. Further, broadband UV breaks down proteins, which improves the efficacy of pathogen kill by the ozone.

Additional methods may be employed to enhance the pesticide efficacy of the ozone generated by this device. Negative pressure may be created inside walls using voids formed in the walls. For example, removal of electrical outlet covers and replacement with attachments for a vacuum pump or other source of negative pressure creates negative pressure inside the walls. Ozone generated by the device is pulled into the interior of the walls to replace air pulled from the walls, allowing for ozone penetration into areas that are susceptible to invasion and/or habitation by pests.

Alternatively, positive pressure channeled from the ozone generator may be used to force ozone into the wall. Similarly, ozone may be forced into materials that are capable of being permeated by the ozone, such as mattresses and upholstered furniture.

Sensors may be positioned at openings in the wall to measure ozone concentrations as ozone exits the interior of the wall or other area.

Where construction methods do not allow for ventilation across wall studs, hollow tubes may be positioned to provide a conduit. By way of example, needles similar to those used to inflate basketballs may be driven into the walls to provide negative or positive pressure and assure ozone penetration into the areas of concern.

A similar measure may be taken with bedding or upholstered or padded furniture. In one embodiment, negative pressure is applied to the bedding from one end, with the entire mattress or other bedding material encased, such as encased in plastic. Ozone generated by the device that is present in the atmosphere of the enclosed area enters the encasement at an opening as result of the negative pressure applied to the encasement. Other objects may be similarly encased for treatment.

Ozone is a most effective agent for removal and control of odors, especially when the odors originate from decomposing organics, such as dead rodents. The device and method have additional uses where expedited oxidation in an enclosed area is beneficial, such as where an animal has perished in the interior of a wall or similar enclosed space that cannot be easily accessed. Ozone levels sufficient for substantially complete macroorganism kill are difficult to obtain with conventional ozone generators unless they are fed with concentrated oxygen. Concentrated oxygen increases the risk of fire, which is unacceptable in many applications, such as treatment of hospitals, nursing homes, hotels, and dormitories. Since the presently described device ionizes oxygen already present in the atmosphere of the building, fire hazards are seemingly lessened as compared to the use of concentrated oxygen. Still, concentrations of ozone may be produced by the device and method that are theoretically as high as 140,000 ppm.

Ozone concentrations that are required vary according to the macroorganism to be eradicated. Generally, larger pests require greater concentration of ozone and/or time of exposure for acceptable kill levels than smaller pests. Ozone produced and applied according to the described methods will kill invertebrates, mammals and reptiles. It is believed that bedbugs are killed at about 1,600 parts per million. Rodents, such as rats, require increased exposure time and/or higher concentrations of ozone.

What is claimed is:

1. A method of pest control, comprising the steps of:
positioning a plurality of ozone generating ultraviolet lamps in an enclosed area of a building;
causing the plurality of ozone generating ultraviolet lamps to generate ozone within the enclosed area of the building;
monitoring an ozone concentration of the ozone in an atmosphere of the enclosed area of the building;
terminating generation of ozone by the ozone generating ultraviolet lamps upon the ozone concentration of the atmosphere of the enclosed area of the building reaching a predetermined concentration of ozone.

2. A method of pest control according to claim 1, further comprising the steps of:
continuing to monitor the ozone concentration of the ozone in the atmosphere of the enclosed area of the building after terminating generation of ozone by the ozone generating ultraviolet lamps;
causing the plurality of ozone generating ultraviolet lamps to again generate ozone within the enclosed area of the building when the ozone concentration of the atmosphere of the enclosed area of the building is below the predetermined concentration of ozone;
terminating generation of ozone by the ozone generating ultraviolet lamps upon the ozone concentration of the atmosphere of the enclosed area of the building reaching the predetermined concentration of ozone.

3. A method of pest control according to claim 1, wherein the predetermined concentration of ozone is not less than 1600 parts per million.

4. A method of pest control according to claim 1, wherein the ultraviolet spectrum of the plurality of ultraviolet lamps is between 100 nm and 300 nm.

5. A method of pest control according to claim 1, wherein the ozone is generated by an ozone generator positioned with the enclosed area of the building, and wherein the ozone generator comprises the ozone generating ultraviolet lamps, and wherein the ozone generating ultraviolet lamps are positioned on the ozone generator to dispense ozone 360 degrees around the ozone generator and within the enclosed area of the building.

6. A method of pest control according to claim 1, wherein the ozone is generated by the ozone generating ultraviolet lamps from atmosphere within the enclosed area of the building.

7. A method of pest control according to claim 1, wherein the ozone generating ultraviolet lamps generate ozone from atmosphere within the enclosed area of the building and wherein the ozone generating lamps are directly exposed to the atmosphere within the enclosed area and produce ozone from the atmosphere that is directly emitted into the enclosed area.

8. A method of pest control according to claim 2, further comprising the step of terminating generation of ozone by the ozone generating lamps after a predetermined time irrespective of the ozone concentration in the enclosed area.

9. A method of pest control according to claim 1, further comprising the steps of reducing atmospheric pressure in an interior of a wall of the area of the building and introducing ozone generated by the ozone generating lamps into the interior of the wall.
